(19) United States
(12) Patent Application Publication
(10) Pub. No.: US 2009/0050307 A1
(43) Pub. Date: Feb. 26, 2009

(54) Steam Generator Pipe, Associated Production Method and Continuous Steam Generator

(76) Inventors: Joachim Franke, Altdorf (DE); Oliver Herbst, Dormitz (DE); Holger Schmidt, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/086,099

(22) PCT Filed: Nov. 22, 2006
(86) PCT No.: PCT/EP2006/068760

§ 371 Date: Jun. 5, 2008

(30) Foreign Application Priority Data
Dec. 5, 2005 (EP) 05026486.0

(51) Int. Cl. F28F 1/14; H05B 6/10; B21D 39/04

(52) U.S. Cl. 165/184; 219/628; 29/890.036

(57) ABSTRACT

The invention relates to a steam generator pipe which can be produced in a simple and economical manner and which has particularly good heat transitional behaviour having a large band width with various operational conditions. According to the invention, at least one insert is arranged in the inner chamber of the pipe in order to form a swirl-generating inner profile. The insert comprises at least one lamination frame having a number of large recesses. The insert is drilled in the longitudinal direction and rests at least partially on the pipe inner wall with the longitudinal edges thereof.

### CROSS REFERENCE TO RELATED APPLICATIONS

This application is the US National Stage of International Application No. PCT/EP2006/068760, filed Nov. 22, 2006 and claims the benefit thereof. The International Application claims the benefits of European application No. 05026486.0 filed Dec. 5, 2005, both of the applications are incorporated by reference herein in their entirety.

### FIELD OF INVENTION

The invention relates to a steam generator pipe with a swirl-generating internal profile. It also relates to a continuous steam generator with steam generator pipes of this type. The invention further relates to a method for producing a steam generator pipe provided with a swirl-generating internal profile.

### BACKGROUND OF THE INVENTION

Steam generator pipes welded together in a gas-tight manner by way of bars are generally used in the combustion chamber walls of a continuous steam generator to form a gas duct enclosing the combustion chamber, said steam generator pipes being connected in a parallel manner for the through-flow of a flow medium. Instead of pipes with separate flat iron bars in between them, pipes can also be used, which have already been equipped in the factory with molded fins. The steam generator pipes can be disposed vertically or even obliquely. So that the continuous steam generator has a reliable operating response, the steam generator pipes are generally designed in such a manner that adequate cooling of the steam generator pipes is ensured even with low mass flow densities of the medium flowing through the steam generator pipes.

The heat transfer characteristics of a steam generator pipe are an important design criterion. A high level of heat transfer allows particularly effective heating of the medium flowing through the steam generator pipe whilst at the same time allowing reliable cooling of the steam generator pipe per se. The heat transfer response of a steam generator pipe can be impaired in conventional steam generators, which are operated at sub-critical pressures, by the occurrence of what are known as boiling crises. This is where the pipe wall is no longer wet by the fluid flow medium—generally water—and is therefore inadequately cooled. The strength values of the pipe wall could then be reduced as a result of premature drying out.

To improve the heat transfer response, steam generator pipes are generally used, which have a surface structure on their inside or an internal profile in the manner of helically wound ribs as a result of a forming process (e.g. cold drawing). The form of the ribs causes the medium flowing through the steam generator pipe to swirl, so that the heavy fluid phase collects on the internal pipe wall due to the action of centrifugal forces, forming a film of wetting fluid there. This ensures a reliable heat transfer from the internal pipe wall to flow medium even where there are relatively high heat flow densities and low mass flow densities.

It is a disadvantage of the known steam generator pipes that they are relatively complex to produce due to the limited formability of the pipe material. The formability of high-temperature resistant steels with a high chromium content in particular is very restricted. Materials of this type currently play an increasingly important role in steam generator pipes, since—in principle at least—they allow a steam generator to be designed for particularly high steam parameters, in particular for high live steam temperatures, and the particularly high levels of efficiency associated therewith. The restrictions due to the material during processing mean however that in practice it is impossible or it is only possible with considerable outlay to produce pipes with internals ribs with the desired rib profiles that are advantageous for flow engineering from plain pipes as part of a forming process. It is problematic in particular to produce sufficiently steep profile angles and sharp-edged transitions in conjunction with large rib heights. Also the height of the ribs can only be produced within a narrow framework. In addition there is little flexibility in respect of profile configuration along the pipe.

Alternatively different types of swirl-generating components have already been proposed for subsequent insertion into a steam generator pipe. These include in particular what are known as twisted tapes. These are tapes made from metal strips, which are twisted or wound. The pipe components known to date however all have the disadvantage that they on the one hand block the (originally) free cross-section in the center of the pipe, thereby resulting in very high pressure losses, and that they on the other hand deflect the entire flow to a very significant extent, thereby “overswirling” to some degree. A simple twisted tape for example results, in the case of higher steam contents in the two-phase flow, in the collection of the water phase in the spandrel between the pipe wall and the tape with simultaneous drying out and therefore inadequate cooling of the internal wall regions in the lee of the tape. Steam generator pipes with components in the manner of twisted tapes are therefore not equally suitable for all operating conditions generally occurring in steam generators.

### SUMMARY OF INVENTION

The object of the invention is therefore to specify a steam generator pipe of the type mentioned in the introduction, which has a particularly favorable heat transfer response in a wide range of different operating conditions as well as being simple and economical to produce. A suitable production method for producing a steam generator pipe of this type and a continuous steam generator are also to be specified, said continuous steam generator having a particularly simple structure as well being extremely safe to operate and highly efficient.

In respect of the steam generator pipe the said object is achieved according to the invention in that at least one insert is disposed in the internal pipe chamber to form a swirl-generating internal profile, with the insertion comprising at least one sheet metal frame with a number of large recesses, with the insert being twisted in the longitudinal direction, and with the longitudinal edges of the respective sheet metal frame resting at least partially on the internal pipe wall.

The invention is based here on the consideration that the multi-phase flow within a steam generator pipe is to have a swirl to improve the heat transfer, so that the fluid phase is guided onto the internal pipe wall due to rotation and wets it as evenly as possible. To produce and maintain a swirling flow of this type in a specific manner, suitable flow-guiding elements should be disposed inside the pipe. As has been proven, the guiding of the flow is particularly favorable, if neither “overswirling” nor excessively high pressure losses occur along the flow path but the swirl effect is still intensive enough to direct the fluid phase of the flow medium onto the internal pipe wall over the entire circumference of the pipe.

To prevent high pressure losses, which result in a high energy requirement for the water supply pump, and to ensure steam dissipation inside the pipe, the flow-guiding elements should be disposed essentially in the manner of an internal profile on the internal pipe wall and should not or should only slightly block the pipe cross-section in the center. Also to avoid the production limitations associated with ribbed pipes of conventional structure, the swirl-generating internal profile should be realized by means of pipe components or inserts, which can be produced in the desired form independently of the steam generator pipe and can then be incorporated in the pipe at a later stage.

For this purpose in the case of the design proposed here a sheet metal frame, which is twisted in the longitudinal direction and whose longitudinal edges rest at least partially but preferably entirely on the internal pipe wall, is disposed in the internal pipe chamber. In an alternative variant an insertable body formed from a number of sheet metal frames and twisted in the longitudinal direction is disposed inside the pipe, with the two longitudinal edges of each wound or twisted sheet metal frame resting on the internal pipe wall. This embodiment is described in more detail below in the description of the figures. In contrast to the hitherto known twisted tapes, the respective sheet metal frame is however provided with a number of large recesses, which can be stamped or cut from the sheet metal material for example. Large here means that the surface covered in total by all the recesses makes up at least 50%, but preferably at least 80%, of the base surface of each sheet metal frame, so that after insertion into the internal pipe chamber a significant part of the pipe cross-section in the center remains free. This allows the steam to accumulate and dissipate undisturbed inside the pipe.

Swirl generation is brought about in a different manner from with the closed twisted tapes by the sections close to the edges, in other words the peripheral bars around the edges of or encompassing the recesses, said peripheral bars winding in a helical manner along the internal pipe wall in each instance, thereby having a similar configuration and function to ribs of conventional ribbed pipes. The negative effects of conventional twisted tapes associated with “overswirling” are avoided. Instead even wetting of the internal pipe wall with fluid flow medium is achieved, even where there is moderate swirl strength and relatively low pressure loss. The transverse bars at the ends and the transverse bars provided in some instances between two recesses disposed respectively one behind the other in the longitudinal direction only have a support function for the pipe insert and only disturb the swirling flow in the center of the steam generator pipe to an insignificant degree.

It is particularly advantageous with the new design that in contrast to the ribbed pipes produced from plain pipes using considerable forming forces by means of a forming process, there is a high level of flexibility in respect of the flow-related parameters, such as number of windings, width of peripheral bars (corresponding to rib height in the case of ribbed pipes), profile angles and edge sharpness. Corresponding design parameters can be implemented in a particularly simple and precise manner with the embodiment in the form of an insertable component, since to this end only one or a number of suitably punched or cut sheets or metal tapes are provided and have to be incorporated by twisting in a plain pipe that is relatively simple to manufacture.

The pipe insert advantageously sits in the internal pipe chamber without slipping due to the torsional stress of the sheet metal frame(s) at the anticipated operating temperature of the steam generator pipe. The sheet metal material and the torsional stress are therefore tailored to geometric conditions in such a manner that the insert cannot creep or slip in the internal pipe chamber.

Although the pipe insert sits relatively firmly and securely in the steam generator pipe due to its geometrical dimensions and its torsional stress, an additional fixing is preferably provided, with which each or at least one sheet metal frame is connected firmly to the internal pipe wall at one point, preferably close to its two ends. The firm connection here is advantageously a high-temperature resistant weld connection. A variant that is slightly more complex to produce but which ensures particularly secure fixing comprises a number of spot welds distributed over the longitudinal edges of the sheet metal frame. The welded fixing can be produced particularly effectively, if the sheet metal frame(s) is/are made of a material with a composition similar to the pipe material.

It is also desirable, specifically in the case of a relatively long steam generator pipe, which extends over the entire height of the steam boiler, to provide different guide profiles inside the pipe depending on location along its longitudinal extension, said guide profiles taking into account the spatial development and variation both of the steam element and also the heating profile. Such a design can advantageously be realized in that a number of inserts are incorporated in the steam generator pipe, being disposed in respectively separate pipe sections, with the geometric parameters of the respective insert being tailored to the local heating effect anticipated during operation and/or the local flow conditions. Since it has also proven that the swirl, after being generated once, is maintained at least over a flow distance of five pipe diameters even in the case of a two-phase flow, it is not necessary to equip the pipe completely with inserts, without gaps. Instead the inserts can be incorporated in the steam generator pipe separated from each other by intermediate spaces.

The steam generator pipes described here are expediently used in a continuous steam generator heated by fossil fuels. The swirl-generating internal profile of the pipes and the improvements in heat transfer response associated therewith mean that an adequate heat transfer to the flow medium or cooling of the pipe walls is ensured even in the case of boiler designs with a vertical pipe arrangement (vertical piping). Vertical piping with a large number of pipes and relatively short pipe lengths allows the steam generator to be operated with reduced pressure loss and reduced minimum throughput due to the lower flow speeds and lower mass flow densities compared with pipes disposed obliquely or in a spiral. The power plant of which the steam generator is part can therefore be designed for a lower minimum load. The separation effects known from angled steam generator pipes, with which water and steam only flow in layers when the flow speed or load drops below a minimum value, so that sub-regions of the pipe walls are no longer wet, do not occur with vertical piping. Also there is no need for complex support structures for the steam boiler, which are associated with extensive and cost-intensive welding work, as a boiler wall with vertical piping can generally be designed to be self-supporting.

The pipe components mentioned can also lead to a reduction in the heat exchanger surface due to the improved heat transfer and therefore also to significant cost savings, even with convective heating as is present for example in the waste heat boilers of gas/steam turbine power plants.

In respect of the production method, the above-mentioned object is achieved in that a body that is prestressed by twisting and consists of one or a number of interconnected sheet metal frames is inserted into the internal pipe chamber, with the stress being eliminated from the body after insertion until its longitudinal edges rest at least partially on the internal pipe wall. In other words, the sheet metal frame(s) is/are prestressed by twisting and inserted into the steam generator pipe in this state with a reduced diameter. After the stress has been partially eliminated, the body automatically presses against the internal pipe wall. The remaining torsional stress is selected here in such a manner that at the anticipated operating temperature of the evaporator pipe no slipping and no untwisting of the sheet metal frame(s) beyond the required degree can occur. The body is also advantageously welded to the internal pipe wall at one end at least.

The advantages achieved with the invention consist in particular in that with the new pipe inserts there is flexible flow guidance in the internal pipe chamber, which can be used for all pipe materials and can be tailored according to the need to improve the heat transfer. The design flexibility achieved by means of the largely freely configurable geometric parameters allows a swirl profile to be set, which varies over the length of the evaporator pipe and is tailored precisely to the respective local heating conditions. This avoids the production limitations of conventional ribbed pipes. In newly developed power plants with higher design values for the steam parameters the manufacture of ribbed pipes is becoming increasingly complex because of the higher chromium content of the new materials required for higher temperatures and pressures. The new swirl-generating inserts can replace the ribbed pipe here or allow such applications for the first time.

### BRIEF DESCRIPTION OF THE DRAWINGS

An exemplary embodiment of the invention is described in more detail below with reference to a drawing, in which:

FIG. 1 shows a simplified diagram of a continuous steam generator with a combustion chamber wall with vertical piping,

FIG. 2 shows a cut-out view of a steam generator pipe with an insert configuring a swirl-generating internal profile, which is made from a single twisted sheet metal frame,

FIG. 3 shows a sheet metal frame provided to form a pipe insert in its original state before twisting,

FIG. 4 shows a cut-out view of a steam generator pipe as in FIG. 2 but with the insert consisting of two sheet metal frames aligned at an angle to each other,

FIG. 5 shows a cross-section through an insert, with a similar structure to the insert in FIG. 4, in two successive production phases before twisting and

FIG. 6 shows a cross-section through a pipe insert according to an alternative embodiment, similarly in two successive production phases before twisting.

Identical elements are assigned the same reference characters in all the figures.

### DETAILED DESCRIPTION OF INVENTION

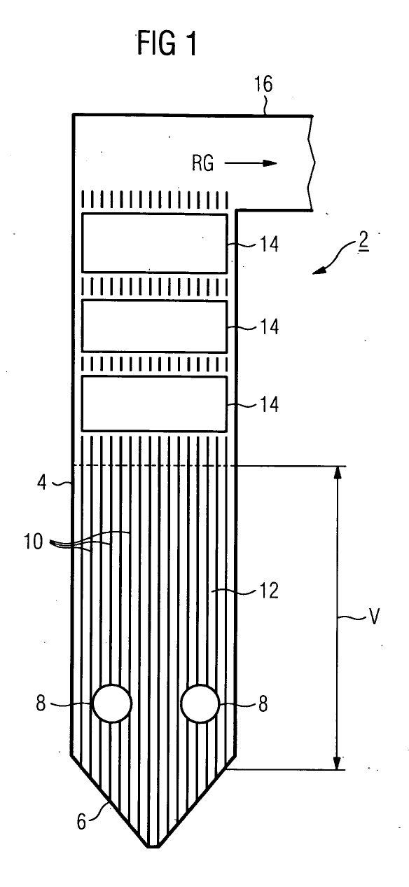

FIG. 1 shows a schematic diagram of a continuous steam generator 2 with a rectangular cross-section, whose vertical gas duct is formed by a peripheral or combustion chamber wall 4, which becomes a funnel-shaped base 6 at the lower end.

In a lighting region V of the gas duct a number of burners for a fuel are positioned in one opening 8 respectively, of which only two are visible, in the combustion chamber wall 4, which is made up of steam generator pipes 10. The vertically disposed steam generator pipes 10 are welded together in a gas-tight manner in the lighting region V to form an evaporator heating surface 12.

Convection heating surfaces 14 are located above the lighting region V of the gas duct. Above these is flue gas outlet channel 16, by way of which the flue gas RG produced by burning a fossil fuel leaves the vertical gas duct. The flow medium flowing in the steam generator pipes 10 is heated by the radiated heat of the burner flames and by convective heat transfer from the flue gas RG and thereby evaporated. The flue gas RG serves as a heating medium for the flow medium flowing in the steam generator pipes 10. The flow medium provided in the exemplary embodiment is water or a water/steam mixture.

In addition to the single pass boiler shown in FIG. 1, other boiler configurations are of course also possible, for example in the manner of a double pass boiler. The steam generator pipes described below can be used with all these variants, both in the lighting region and in the remainder of the flue gas channel. Use in a waste heat steam generator is also possible.

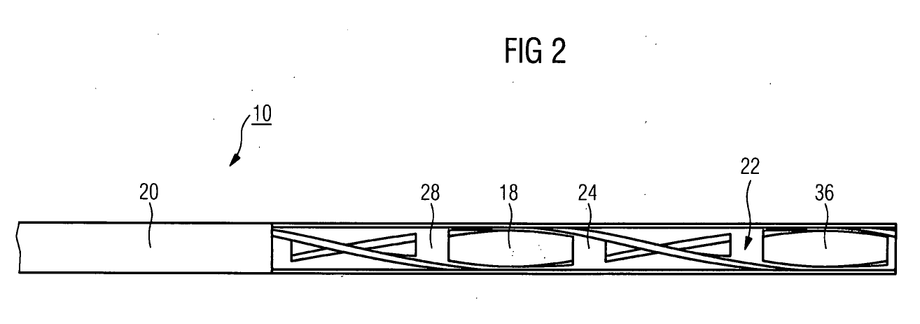

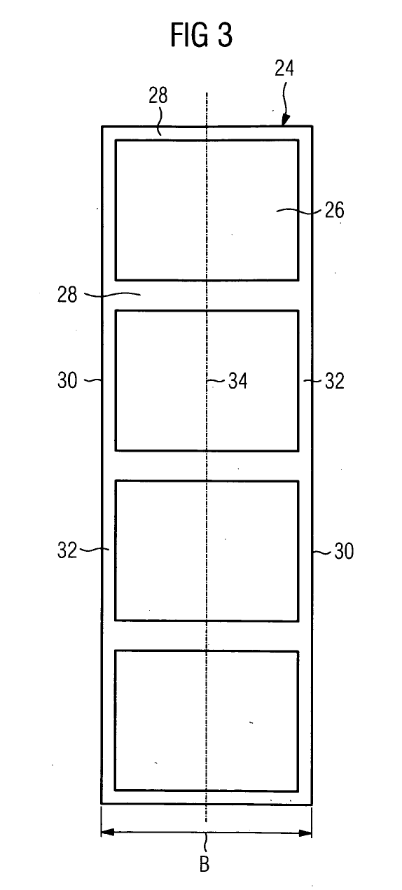

FIG. 2 shows a cut-out view of a section of a steam generator pipe 10 used for the piping of the combustion chamber wall 4 of the continuous steam generator 2. An insert 22 is inserted into the internal pipe chamber 18 of a plain pipe 20, said insert 22 being configured as a swirl-generating internal profile to improve the heat transfer response. In the exemplary embodiment the insert 22 comprises a sheet metal frame 24, twisted in the longitudinal direction, in other words about the pipe axis, having a number of large recesses 26. The width B of the sheet metal frame 24 shown in FIG. 3 before being twisted is slightly larger here than the pipe diameter of the plain pipe 20 provided to receive it. The rectangular recesses 26 are disposed one behind the other in a row when viewed in the longitudinal direction and are separated from each other by narrow transverse bars 28. In the transverse direction the recesses 26 extend almost over the entire width B of the sheet metal frame 24 and are thereby separated from the two longitudinal edges 30 by narrow peripheral bars 32.

The sheet metal frame 24 is now twisted about its longitudinal axis 34 and inserted in this prestressed state into a plain pipe 24 provided as a steam generator pipe 10. The width B of the sheet metal frame 24 is hereby dimensioned in relation to the pipe diameter in such a manner that the stress of the sheet metal frame 24 can be partially eliminated, so that in the final assembly state the peripheral bars 32 are wound along a predetermined helical line on the internal pipe wall 36. The remaining residual stress then fixes the sheet metal frame 24 securely in the internal pipe chamber 18. The peripheral bars 32 of the sheet metal frame 24 are also welded to the internal pipe wall 36 at a number of points.

The sheet metal frame 24, like the pipe wall 38 of the plain pipe 20 receiving it, is made of a high-temperature resistant metal material with a high chromium content. Other suitable materials familiar to the person skilled in the art can of course also be used. Because the sheet metal frame 24 is produced separately from the plain pipe 20, the height and width of the peripheral bars 24 in particular as well as the angle of pitch of the helical lines formed by the longitudinal edges 30 can be predetermined as required. In a first approach the geometric parameters are generally selected to be similar to those of the ribs of conventional ribbed pipes. However a location-dependent adjustment and optimization can also be carried out, taking into account the pattern of the heating profile along the combustion chamber wall 4.

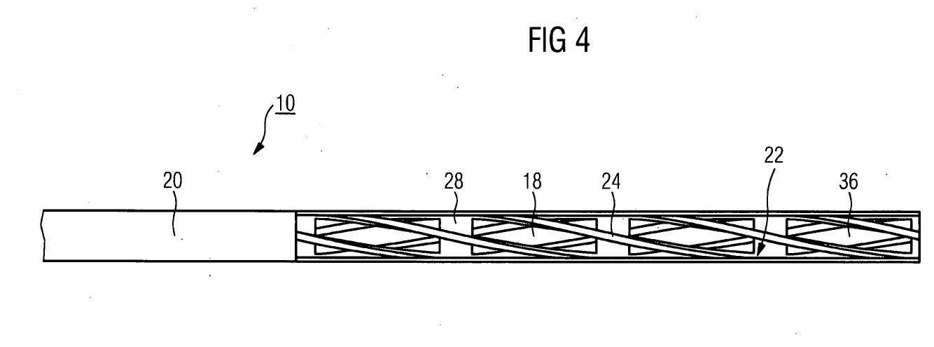

FIG. 4 also shows a cut-out view of a steam generator pipe 10 with an insert 22, which consists of two sheet metal frames 24 connected together and aligned at an angle to each other. Each of the two sheet metal frames 24 has large recesses 26 like the sheet metal frame 24 shown in FIG. 3. The peripheral bars 32 of the two sheet metal frames 24, which wind respectively in a helical manner on the internal pipe wall 36 overall form a swirl-generating internal profile in the manner of a four-pitch thread. Compared with the internal profile of the insert 22 according to FIG. 2 formed in the manner of a two-pitch thread, it is possible to generate a swirling flow resulting in even wetting of the internal pipe wall 36 with a fluid film in an even more effective manner, particularly with relatively large internal pipe diameters.

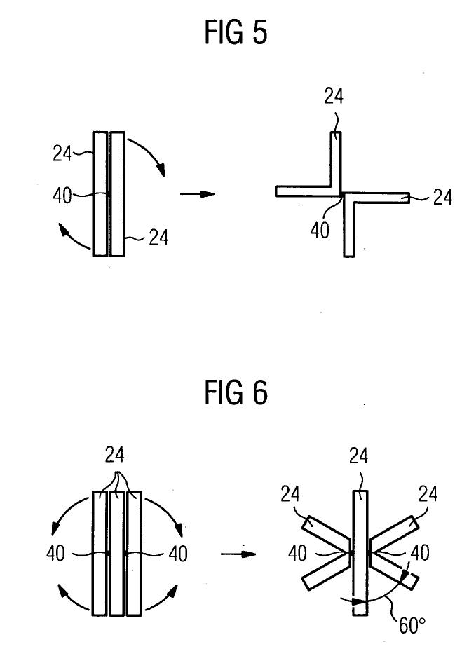

FIG. 5 shows a particularly simple and expedient production method for an insert 22 of this type. To this end, as shown in a cross-sectional diagram on the left of FIG. 5, two sheet metal frames 24 of the same type, each being configured in a similar manner to the sheet metal frame 24 shown in FIG. 3, are laid precisely on top of each other and welded together respectively around the center of their transverse bars 28 (spot weld 40). The two sheet metal frames 24 are then bent through around 90° along their longitudinal axes in the manner shown in FIG. 5, so that the structure with an approximately cross-type cross-section shown on the right of FIG. 5 results. The insert 22 is finally twisted in the longitudinal direction and inserted into a plain pipe 20.

An insert 22 made up of three interconnected sheet metal frames 24 can be produced in a similar manner as required (FIG. 6), forming a swirl-generating internal profile in the manner of a six-pitch thread after being twisted and inserted into a plain pipe 20.

1-11. (canceled)

12. A steam generator pipe, comprising:
a pipe arranged along a longitudinal direction and having an internal pipe chamber; and
an insert arranged in the internal pipe chamber forming a swirl-generating internal profile, wherein
the insert comprises one or more sheet metal frames with a plurality of recesses, and
the insert is twisted in the longitudinal direction with the insert longitudinal edges resting at least partially on an internal pipe wall.

13. The steam generator pipe as claimed in claim 12, wherein each recess is separated from opposite longitudinal edges of the sheet metal frame respectively by a peripheral bar.

14. The steam generator pipe as claimed in claim 12, wherein a plurality of recesses arranged one behind the other in the longitudinal direction in the sheet metal frame are separated from each other by narrow transverse bars.

15. The steam generator pipe as claimed in claim 12, wherein the insert sits in the internal pipe chamber without slipping due to insert torsional stress at the anticipated operating temperature.

16. The steam generator pipe as claimed in claim 12, wherein the insert is secured to the internal pipe wall at at least one point close to the inserts two ends.

17. The steam generator pipe as claimed in claim 16, wherein the insert is welded to the internal pipe wall.

18. The steam generator pipe as claimed in claim 17, wherein the insert is made of a material with a composition similar to the pipe material.

19. The steam generator pipe as claimed in claim 18, further comprising a plurality of inserts arranged in respectively separate pipe sections, where the geometric parameters of the respective insert are tailored to the operative local heating and/or flow conditions anticipated during operation.

20. A continuous steam generator, comprising:
a plurality of pipes arranged along a longitudinal direction and each pipe having an internal pipe chamber; and
a plurality of pipe inserts, each insert arranged in the internal chamber of each pipe, where each insert forms a swirl-generating internal profile, wherein
each insert comprises one or more sheet metal frames having a plurality of recesses, and
each insert is twisted in the longitudinal direction with the insert longitudinal edges resting at least partially on an internal wall of the respective pipe.

21. A method for producing a steam generator pipe, comprising:
providing a pipe having an internal pipe wall and an associated internal chamber;
providing a sheet metal frame;
pre-stressing the sheet metal frame into a swirl-generating insert by forming and twisting the frame;
inserting the pre-stressed insert into the internal pipe chamber of the pipe; and
at least partially eliminating the pre-stress from the insert until the longitudinal edges of the sheet metal frame rest at least partially on the internal pipe wall.

22. The method as claimed in claim 21, further comprising welding the insert at at least one end to the internal pipe wall after the pre-stress has been partially eliminated.
